(19) United States
(12) Patent Application Publication
(10) Pub. No.: US 2009/0125570 A1
(43) Pub. Date: May 14, 2009

(54) Online backup and restore

(75) Inventors: Christopher R. Bailey, Eugene, OR (US); Robert Gager, Cupertino, CA (US); Mohit Gupta, Noida (IN); Sreedhar Ranganathan, Chennai (IN); Darin E. Krauss, Auburn, CA (US); Tapani Otala, San Jose, CA (US); Mario Schroder, Hamburg (DE); Alok Kumar Singh, Noida (IN)

Correspondence Address: VAN PELT, YI & JAMES LLP AND ADOBE SYS. INCORP., 10050 N. FOOTHILL BLVD., SUITE 200, CUPERTINO, CA, 95014, US

(73) Assignee: Adobe Systems Incorporated

(21) Appl. No.: 11/985,085

(22) Filed: Nov. 13, 2007

(51) Int. Cl. G06F 17/30

(52) U.S. Cl. 707/204; 707/E17.019

(57) ABSTRACT

Online backup of image files includes providing a user interface for making a backup selection based on an image catalog that includes a plurality of image files, the user interface including a resolution option; receiving a backup selection based on the image catalog, the backup selection indicating a selection of an image file in the image catalog and a resolution choice associated with the image file; and sending a copy of the image file to a remote storage, the copy having a resolution that corresponds to the resolution choice.

### BACKGROUND OF THE INVENTION

Digital photography and videography are becoming increasingly popular as the quality of equipment continues to improve while the price continues to decrease. More and more digital images and video are being created for personal and commercial use. Traditionally, users handle their own image and video backups by copying the data to storage media such as CDs, DVDs, magnetic tapes, external hard drives, etc. With increased data volume, backups can be expensive since additional equipment and media have to be purchased. The typical backup process is also troublesome because it often involves many manual steps. Furthermore, most users do not have proper offsite backup, and therefore could lose precious images in case of fire, flood, or other disasters. It would be useful, therefore, to have improved backup techniques.

### BRIEF DESCRIPTION OF THE DRAWINGS

Various embodiments of the invention are disclosed in the following detailed description and the accompanying drawings.

FIG. 1 is a block diagram illustrating an embodiment of an image file management system.

FIG. 2 is a flowchart illustrating an embodiment of a process for updating a backup catalog.

FIG. 3 is a diagram illustrating an example screenshot of the configuration user interface for making backup selection.

FIG. 4 is a flowchart illustrating an embodiment of a process for synchronizing image catalog backup.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Online image file backup and restore is described. In some embodiments, a user makes a backup selection based on an image catalog, and chooses a resolution associated with one or more files selected for backup. A copy of the selected image file is sent to a remote storage, where the copy has a resolution that corresponds to the resolution choice.

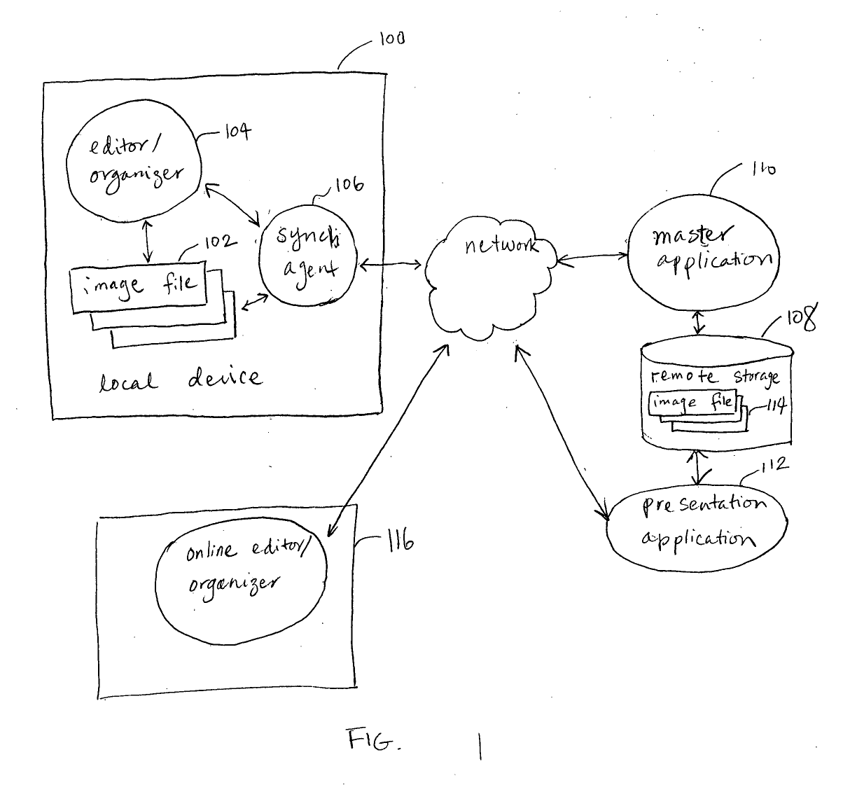

FIG. 1 is a block diagram illustrating an embodiment of an image file management system. A set of digital files 102 is stored on a local device 100. The image and/or video files may include files in a variety of formats, including Joint Photographic Experts Group (JPEG), Graphics Interchange Format (GIF), Motion Picture Experts Group (MPEG) and Tagged Image File Format (TIFF), and Portable Network Graphics (PNG). Although digital photo images are described in the examples herein, other types of files, including audio, video, streaming video, or graphical data, may be used in various embodiments. The local device may be a desktop or portable computer, a personal digital assistant (PDA), a camera, a cell phone, or other types of handheld multipurpose device.

An application 104 operates on the local device, providing editing functions such as cropping, rotating, sharpening, redeye reduction, etc. The application also provides organizational functions such as tagging, labeling, and sorting photos into various albums, thus allowing the user to more easily manage the image files stored on the device. Adobe Photoshop™ and Photoshop Elements™ are examples of this type of editors/organizer application. Using the editor/organizer, the user can organize image files stored on the local device into an image catalog 102. As used herein, an image catalog refers to a collection of image files as well as metadata describing the organization of the image files such as file hierarchy, relationship, etc.

The image catalog is transferred over a network (e.g. the Internet) to a backup server, and a backup copy 114 is created on a remote storage device 108. Other devices (if so configured and/or so desired) such as device 116 can access the backup catalog by communicating with a presentation application 112 running on the server side. Additional server components are included in some embodiments to facilitate the operations. For example, an account manager is included in some embodiments to handle user registration and login. Some embodiments include a billing manager to handle billing related activities.

A synchronization agent 106 residing on local device 100 communicates with the editor/organizer to back up and synchronize the local image catalog with a backup image catalog. The synchronization agent may be implemented as a process separate from the editor/organizer, or as a part of the editor/organizer. Details of respective embodiments of the editor/organizer and the synchronization agent are discussed in further detail below.

In some embodiments, image catalog 102 and/or 114 is associated with and/or is formatted according to an application, such as Adobe® Photoshop® Elements. In some embodiments, an image catalog includes settings, preferences, and/or metadata associated with an application. In some cases, this enables a user to have her preferences and/or settings for a particular application be saved, restored, and/or accessed from another device, portal, and/or interface. In some embodiments, an image catalog includes (and what is backed up includes): user assigned tags, collages created from multiple photographs, and/or scrapbooks with multiple pages, each page having graphics, text, backgrounds, and/or images.

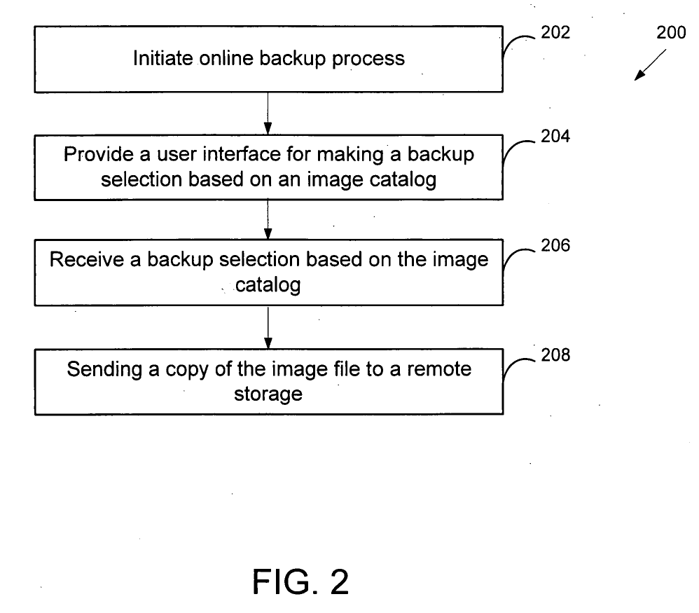

FIG. 2 is a flowchart illustrating an embodiment of a process for updating a backup catalog. Process 200 may be implemented on the local device. The process may be used to create or modify the backup catalog. At 202, the online backup process initiates. There are a number of ways to initiate the process. For example, in some embodiments, the process initiates when the user logs onto his account on the server, and chooses to do a backup, for example by pressing a backup button or other interaction with a user interface. In some embodiments, a process for updating a backup catalog initiates as a part of an automatic periodic backup service that operates on the local device. At 204, a user interface (UI) that allows the user to make a backup selection based on an image catalog is provided. In some embodiments, the user is presented with an overview of the catalog, and is allowed to switch to other view for organizing the catalog, such as a view of certain tagged images, a view of a particular photo album, or the like. The UI may allow the user to select individual files, all the files, or subsections of the image catalog, etc. In some embodiments, the default settings depend on the state of the backup catalog. For example, if there is no existing backup catalog, the entire image catalog is selected by default to be sent to the remote storage for creating a new backup catalog, and the user can un-select the images that he does not wish to backup. If, however, the image catalog has previously been backed up, only the new or edited files are selected by default to be backed up.

In this example, it is assumed that the user has been allocated a specific amount of storage space. In some embodiments, backup is a subscription or fee based service and the amount of storage is determined based on the user's service/subscription level, account type, or other appropriate factors. In some embodiments, the user can purchase additional storage space (e.g., by communicating with an account manager program via a user interface). An indication of storage status information is displayed in some embodiments. As will be described in more detail below, the storage status display gives the user graphical feedback of his backup storage space usage. Based on the information, the user can adjust the selection of files to be backed up. For example, the user has the option to un-select some files to conserve storage space. Alternatively, the user can choose to keep certain types of files, such as video files or files greater than a certain size, from being backed up. In some embodiments, the user has the option to change the resolution of the files in the backup catalog. The storage information display is adjusted contemporaneously to reflect changes to the selection and/or configuration of the files to be backed up.

Once the user has finalized his backup options, a backup selection is generated and received by a synchronization agent (206). The backup selection indicates which image and/or video files in a catalog should be uploaded and any corresponding values or settings, such as a resolution option. The resolution option allows the user to select a resolution for the image file stored on the backup storage, such that the resolution of each copy stored on the backup is not necessarily the same as the original. In some embodiments, the synchronization agent is a part of the editor/organizer application. In some embodiments, the synchronization agent is a stand-alone process or application that cooperates with the editor/organizer application. Copies of the selected image files each having a resolution that corresponds to the user selected resolution choice are sent to the remote storage (208). In the event that a lower resolution option is selected, the synchronization agent undertakes the task of resizing the image file to generate a lower resolution image file for the backup.

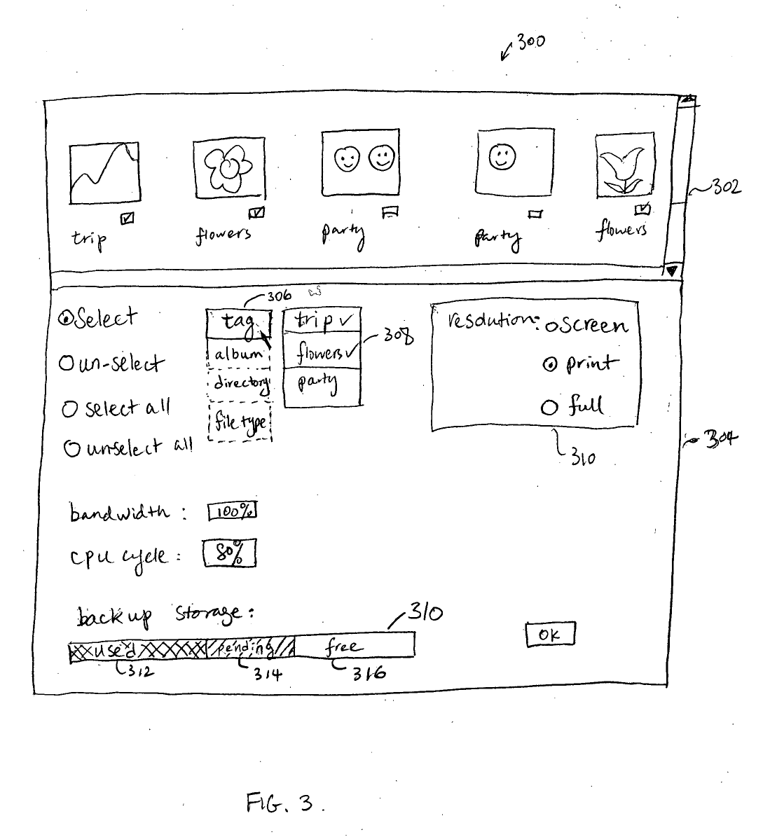

FIG. 3 is a diagram illustrating an example screenshot of the configuration user interface for making backup selection. The editor/organizer application may incorporate screen 300 to provide a user interface for selecting files and configuring backup options. Screen section 302 is a display area showing a thumbnail view of the image catalog. The user may select or un-select a file by checking or un-checking a corresponding checkbox. Screen section 304 is a configuration area showing various configuration options, including Select-All, Un-Select-All, Select, and Un-Select. The latter two options are used in conjunction with other options such as tags, directories, albums, and file types to make compound selections.

In some embodiments, selecting an appropriate item in selection menu 306 will create additional context specific choices 308. In other words, additional choices corresponding to the selected item are made available to the user. For example, when “tag” is selected, tags that were previously created by the user, in this case “trip”, “flowers”, and “party” are presented, and the user may select or un-select a collection of images associated with a specific tag. When “file type” is selected, different types of files such as .JPEG, .TIFF, .MPEG, .PGN, etc. are presented, and the user may select or un-select a specific type of file. In some embodiments, there may be additional hierarchical layers associated with each menu choice. For example, one “directory” is selected, several levels of subdirectories may be displayed and selectable by the user. Different options may be included in other embodiments. When a group of images are selected this way, the user still has control over individual images and can make an individual decision on whether to backup the specific image. For example, if the user chooses a particular album for backup, he can un-select some images within the album so that they are not a part of the backup selection.

Resolution area 310 presents several resolution choices. The resolution choices provide a simple and intuitive way for the user to adjust the amount of data to be backed up. In this example, the user may choose from “screen”, “print”, and “full”. Screen resolution corresponds to a resolution level that is sufficient for displaying the image on a computer monitor. Print resolution corresponds to a resolution level that is sufficient for producing a standard size print. For example, a resolution of 1536×1024 pixels is sufficient to produce a good 8×10 size print. Full resolution corresponds to the resolution of the original image file. Thus, if the user had many high resolution images on the local device, but ultimately only wants to be able to restore from the server files from which he can make regular prints, he can select a lower resolution option to conserve backup storage space.

In some embodiments, a user is able to select different settings for one image or video compared to another. For example, a user may want one image or video to be saved with full resolution but another image or video to be saved with screen resolution.

Storage status display 310 presents storage space related information in a graphical display. Sections 312, 314 and 316 of the status bar indicate to the user, respectively, the amount of backup space currently occupied by existing backup files, the amount that is pending (i.e., the storage space size that is required to store the user's current selection of files for backup based on the current settings for those selected images and/or video), and the amount of free space that will remain assuming that all the selected files are backed up. While a status bar is illustrated in this example, other interface or display devices, such as a pie chart may be used to reflect the status. In this example, the total length of the bar indicates the total amount of storage space available to this user. In some embodiments, if the amount available plus the amount pending exceeds the total amount available, the user will be prompted to either reduce the size of the backup selection or purchase additional space. The user can make adjustments to his backup selection based on the feedback. For example, if there is insufficient space, he can un-select some files, reduce the resolution, or take any other appropriate measures to ensure that his image catalog is successfully backed up. The display updates contemporaneously as the user makes changes to his selection, giving the user instant feedback on how much space the backup selection would consume. In some embodiments, a percentage and/or amount of memory is displayed with storage status display 310. For example, sections 312, 314 and 316 may show 40%, 25%, and 35% and/or 8 GB, 5 GB, and 7 GB if there are 20 GB total.

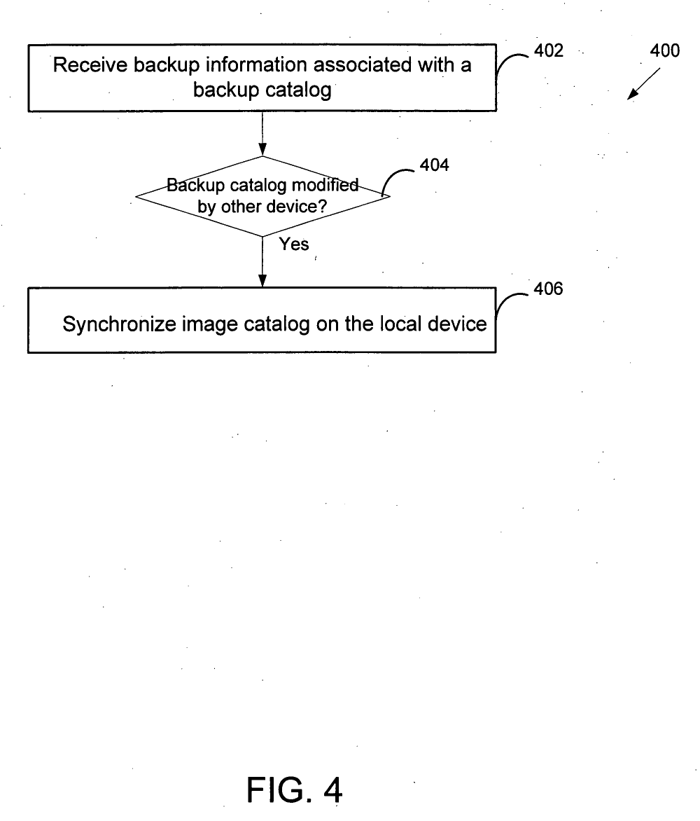

Once an image file is backed up on the remote storage, it can be accessed by the user via a computer network, as well as shared with other users on the network. If the backup catalog is modified, especially if it is modified from a device other than the local device storing the original image catalog, the original image catalog should be synchronized to reflect the changes. FIG. 4 is a flowchart illustrating an embodiment of a process for synchronizing image catalog backup. Process 400 may be implemented on the local device as a part of the editor/organizer application. In this example, process 400 begins when information associated with a backup catalog is received (402). Returning to FIG. 1 for an example, after backup catalog 114 is created on a remote storage, based on local image catalog 102, the owner of the original image catalog (or a different user to whom the owner has granted editing privilege) may log on from a different device such as 116 and edit backup catalog 114. In some embodiments, the editing capability is provided by an online editor/organizer application, such as a browser-based application that communicates with presentation application 112. The server tracks changes, and sends information relating to changes in the backup catalog to the local device when the local device comes online and accesses backup services. In this example, the information received includes metadata describing any changes to the backup catalog since the last time the backup catalog and the image catalog were synchronized.

Based on the information received, it is determined whether the backup catalog has been modified via a device other than the local device (404). If no modification has occurred, further action is not necessary. In the event that the backup catalog has been modified, the image catalog on the local device is synchronized (408), where newly added or modified files are copied onto the local device. In some embodiments, backup files edited via the online interface do not override the original. Instead, an edited version is saved as a new file with a new identifier, and copied to the local device during the synchronization process.

Bandwidth Throttling

In some embodiments, bandwidth throttling is performed. In the following embodiment, an example is described where bandwidth throttling is performed by a Transfer Engine.

In this example, the Transfer Engine is designed to work in the background all day or whenever the computer is active. The example Transfer Engine is designed to also handle backup and restore jobs that can take days of time. The example Transfer Engine operates against a server (e.g., developed by Adobe), and therefore it is possible to mange the bandwidth usage from the client perspective as well as from the server perspective. The example bandwidth throttling solution is not only about having more than one strategy applicable, it is about all strategies working closely together enabling a broad bandwidth management. This allows management of the available network resources in an optimized way for multiple situations. Being able to react to changes in network uses and accordingly switch to an appropriate strategy.

If the application in the foreground needs network bandwidth (e.g., internet browsing) or the user has other background processes running that need network bandwidth (e.g., OS updater) the Transfer Engine shares the available bandwidth in a defensive way. For example, this includes not blocking other applications, especially foreground applications like Internet browsers.

If no application running currently needs network bandwidth, the Transfer Engine recognizes the idle network interface of the local machine. Even if the entire bandwidth is currently available for up/downloads, the Transfer Engine in some embodiments opens only a number of simultaneous connections and only transfers at a rate the server is able to handle. This avoids flooding the server and the available bandwidth is used effectively.

To achieve this, the example Transfer Engine performs the following:

The Transfer Engine initiates a handshake with the server before initiating any transfer jobs. The server sends information about the number of simultaneous network connections and the amount of bytes to up/download per second (i.e., a transfer or data rate). If the server is busy and the returned value is zero the server will provide an amount of time the Transfer Engine has to wait. The Transfer Engine limits the amount of connections and transfer rate according to the given information.

The Transfer Engine monitors its current transfer rate by measuring the amount of bytes that are handed over to the network stack per second. In addition, the server sends back the amount of data it receives from the client. This gives us a more accurate indication of the transfer rate and information for error handling.

The Transfer Engine measures the transfer rate of the local machine in order to adapt to the current circumstances and increase or decrease the bandwidth the Transfer Engine uses accordingly.

In some embodiments, the amount of bandwidth to be used by the Transfer Engine is presented in a Windows System Tray like tool where the user can select settings like “none,” “low,” “medium,” and “high” or a percentage of bandwidth to use from 0 to 100%.

In some embodiments, a Transfer Engine stores the transfer rate of previous up/downloads and uses the stored rates as preset values for a later up/download. In various embodiments, a median is used, the latest values are used, etc.

Progress Management

In some embodiments, progress management is performed. In the following example, progress management is performed by a Progress Manager. A Transfer Engine opens multiple connections for up and download simultaneously. Having multiple connections, it is possible to get status information for the current network transfers multiple times.

Each network transfer is processed in a separate thread, but a single or central Progress Manager displays this progress/status information to the user. The Progress Manager collects the status information from each connection thread. The data is stored in a data map containing an index of the connection object and the connection object itself. To collect the data, a callback technique is used, where the update of the data is protected by critical sections due to the multithreaded access.

Driven by a timing mechanism, a snapshot of the information collected is processed into an interchangeable format (e.g., Extensible Markup Language (XML)) and transferred (e.g., via Adobe's Bridge Talk) to the client application that is able to display the progress information in a user interface. In some embodiments, data is aggregated or combined together as appropriate (e.g., adding the number of bytes transferred by individual network connections, averaging data rates for individual network connections, etc.)

After creating the XML snapshot of the current progress information, the values stored in the Progress Manager are reset and collecting starts again until the timer initiates the next XML snapshot.

Resume Uploads and Downloads

In some embodiments, the system is configured to be able to resume up/down load of data. In the following example, this is performed by a Transfer Engine. The Transfer Engine is designed to handle files of small and large file sizes. In some cases, a user shuts down a local machine before all uploads or downloads are processed. In the case of processing small files it is relatively inexpensive to start the up- or download of the entire file again from the beginning. In the case of large files (e.g., a long video) starting over again would consume a lot of time and network bandwidth. In a worst case scenario, an up- or download of a large file would never finish because the network transfer would take more time that the user is online.

For downloads, HTTP/1.1 introduced range retrieval request to download only the desired part of an Internet resource. A similar mechanism for uploading is missing in HTTP/1.1. To overcome this, a server interface is offered which allows uploading single data chunks of a large file and which recombines the chunks on the server side. If the upload is interrupted, transfer resumes where it was interrupted or left off. All chunks that have been uploaded to the server remain valid and do not need to be resent. After the upload of the last chunk, the server recombines the chunks as a single file.

To make sure that the chunks all belong to the same file version, the client in some embodiments generates a MD5 hash of the entire file before uploading the chunks. The hash is transferred along with the chunks. The server compares the transmitted MD5 hash with the one it generates from the recombined file.

In some embodiments, the chunks are also indexed (e.g., enumerated so that the first chunk has an index of 1, the second chunk has an index of 2, etc.) to enable the Transfer Engine to upload the chunks simultaneously and to enable the server to recombine them in the correct order.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
providing a user interface for making a backup selection based on an image catalog that includes a plurality of image files, the user interface including a plurality of resolution options;
receiving a backup selection based on the image catalog, the backup selection indicating a selection of an image file in the image catalog and a chosen resolution option associated with the image file; and
sending a copy of the image file to a remote storage, the copy having a resolution that corresponds to the chosen resolution.

2. The method of claim 1, wherein the resolution options include a print resolution option.

3. The method of claim 1, wherein the resolution options include a screen resolution option.

4. The method of claim 1, wherein the user interface includes a graphical display of backup storage status.

5. The method of claim 4, wherein the graphical display of backup storage status indicates a pending amount of storage space required for storing a current selection of backup files.

6. The method of claim 4, wherein the graphical display of backup storage status indicates a used amount of storage space occupied by existing backup files.

7. The method of claim 5, wherein the graphical display of backup storage status further indicates a used amount of storage space by existing backup files; and the method further comprising producing a prompt if the sum of the pending amount and the used amount exceeds a total amount of available storage space.

8. The method of claim 4, further comprising receiving an adjusted backup selection, and adjusting the graphical display of backup storage status based on the adjusted backup selection.

9. The method of claim 1, wherein sending the copy includes receiving from a device other than a local device a number of simultaneous network connections to be established and/or transfer rate at which to exchange information.

10. The method of claim 9, wherein if the number of simultaneous network connections to be established and/or the number of transfer rate at which to exchange information equals zero, copying further includes:
receiving from the non-local device an amount of time to wait; and
communicating with the non-local device after the amount of time to wait is over.

11. The method of claim 1 further comprising:
storing a transfer rate used to exchange information at a first point in time; and
exchanging information at a second point in time that is later than the first point in time using the stored transfer rate.

12. The method of claim 1, wherein sending the copy includes dividing the copy into a plurality of chunks to be sent.

13. The method of claim 12 further comprising generating a hash based on the copy of the image file and sending the hash to the remote storage.

14. The method of claim 12 further comprising enumerating the plurality of chunks.

15. The method of claim 1, wherein sending the copy includes establishing a plurality of simultaneous network connections and the method further includes:
obtaining, at a device other than the local device, status related information from each of the plurality of simultaneous network connections;
transferring the status related information to the local device; and
displaying the status related information at the local device.

16. A computer program product embodied in a computer readable medium and comprising computer instructions for:
providing a user interface for making a backup selection based on an image catalog that includes a plurality of image files, the user interface including a plurality of resolution options;
receiving a backup selection based on the image catalog, the backup selection indicating a selection of an image file in the image catalog and a chosen resolution option associated with the image file; and
sending a copy of the image file to a remote storage, the copy having a resolution that corresponds to the chosen resolution.

17. The computer program product of claim 16, wherein the resolution options include a print resolution option.

18. The computer program product of claim 16, wherein the resolution options include a screen resolution option.

19. The computer program product of claim 16, wherein the user interface includes a graphical display of backup storage status.

20. The computer program product of claim 19, wherein the graphical display of backup storage status indicates a pending amount of storage space required for storing a current selection of backup files.

21. The computer program product of claim 19, wherein the graphical display of backup storage status further indicates a used amount of storage space occupied by existing backup files.

22. The computer program product of claim 20, wherein the graphical display of backup storage status indicates a used amount of storage space occupied by existing backup files; and the computer program product further comprising computer instructions for prompting a user in the event that sum of the pending amount and the used amount exceeds a total amount of storage space available to the user.

23. The computer program product of claim 19, further comprising computer instructions for receiving an adjusted backup selection, and adjusting the graphical display of backup storage status based on the adjusted backup selection.

24. A method, comprising:
receiving information associated with a backup catalog, wherein the backup catalog is a backup copy of an image catalog, the backup catalog is stored on a remote storage and the image catalog is stored on a local device;
determining that the backup catalog has been modified via a second device that is a device other than the local device;
automatically synchronizing the image catalog on the local device with the backup copy.

25. A computer program product embodied in a computer readable medium and comprising computer instructions for:
receiving information associated with a backup catalog, wherein the backup catalog is a backup copy of an image catalog, the backup catalog is stored on a remote storage and the image catalog is stored on a local device;
determining that the backup catalog has been modified via a second device that is a device other than the local device;
automatically synchronizing the image catalog on the local device with the backup copy.
